(19) United States
(12) Patent Application Publication
(10) Pub. No.: US 2011/0261136 A1
(43) Pub. Date: Oct. 27, 2011

(54) THERMAL HEAD PRINTER

(75) Inventors: Yusuke NAKAMURA, Kanagawa (JP); Kiyotaka Dochi, Kanagawa (JP)

(73) Assignee: Sony Corporation, Tokyo (JP)

(21) Appl. No.: 13/078,513

(22) Filed: Apr. 1, 2011

(30) Foreign Application Priority Data
Apr. 23, 2010 (JP) 2010-100046

(51) Int. Cl. B41J 11/66

(52) U.S. Cl. 347/218

(57) ABSTRACT

A thermal head printer includes a loading unit on which a printing paper is loaded, a conveying unit sending away and conveying the printing paper from the loading unit, a cutter mechanism unit including a cutter that cuts the printing paper, an ejecting unit to which the printing paper is ejected, a ribbon driving unit including a ribbon tray, a supply reel, and a take-up reel, a printing head that is pressed to the ink ribbon and sublimates ink so as to perform printing with respect to the printing paper, and a tension imparting unit that imparts force in a direction repulsive to a pressing direction of the printing head to the ink ribbon when the printing head is pressed to the ink ribbon and thereby force in a direction in which the ink ribbon is drawn out from the supply reel is imparted to the ink ribbon.

### BACKGROUND OF THE INVENTION

1. Field of the Invention

The present invention relates to a technical field of a thermal head printer. In particular, the present invention relates to a technical field to enhance printing speed with respect to a printing paper while preventing an occurrence of printing unevenness.

2. Description of the Related Art

Among printers, there is a thermal head printer which presses a printing head to an ink ribbon and sublimates ink applied to the ink ribbon so as to perform printing with respect to a printing paper.

Some thermal head printers are provided with a ribbon driving unit which includes a supply reel and a take-up reel. In such thermal head printers, an ink ribbon supplied from the supply reel is taken up by the take-up reel and a printing head is pressed to the ink ribbon, which is supplied at the start of printing, by an operation of a head mechanism unit.

In the above-described thermal head printers in which the printing head is pressed to the ink ribbon at the start of printing, the ink ribbon may be loosened when the printing head is pressed to the ink ribbon. If the printing is performed by such loosened ink ribbon, printing failure may occur due to printing unevenness.

Accordingly, among thermal head printers of the related art, there is a printer which is provided with a torque limiter which is provided at a rotating shaft of a supply reel and is capable of changing a limiting value of a torque, so as to eliminate the looseness of the ink ribbon. The torque limiter detects a diameter of an ink ribbon which is wound around the supply reel, and decreases the limiting value of the torque as the diameter of the ink ribbon is decreased (refer to Japanese Unexamined Patent Application Publication No. 2007-062032, for example).

### SUMMARY OF THE INVENTION

However, in the thermal head printer of Japanese Unexamined Patent Application Publication No. 2007-062032, the supply reel has to be rewound immediately before the start of printing so as to eliminate the looseness of the ink ribbon. Therefore, it takes time to perform this rewinding before the start of the printing, obstructing enhancement of printing speed.

It is desirable to provide a thermal head printer which realizes enhancement of printing speed with respect to a printing paper while preventing an occurrence of printing unevenness.

A thermal head printer includes a loading unit on which a printing paper that is wound in a roll shape is loaded, a conveying unit configured to send away the printing paper from the loading unit and convey the printing paper, a cutter mechanism unit configured to include a cutter that cuts the printing paper on which printing is performed, an ejecting unit to which the printing paper that is cut by the cutter is ejected, a ribbon driving unit configured to include a ribbon tray, and a supply reel and a take-up reel that are separately supported on the ribbon tray in a rotatable manner and around which an ink ribbon and the printing paper are wound, a printing head configured to be pressed to the ink ribbon and sublimate ink that is applied to the ink ribbon, so as to perform printing with respect to the printing paper, and a tension imparting unit configured to impart force in a direction repulsive to a pressing direction of the printing head to the ink ribbon when the printing head is pressed to the ink ribbon and thereby force in a direction in which the ink ribbon is drawn out from the supply reel is imparted to the ink ribbon at a part between the supply reel and the take-up reel of the ribbon driving unit.

Accordingly, in the thermal head printer, when the printing head is pressed to the ink ribbon, the force in the direction repulsive to the pressing direction of the printing head is simultaneously imparted to the ink ribbon.

In the thermal head printer described above, it is preferable that the tension imparting unit be provided with a ribbon guide that is pressed to the ink ribbon so as to impart tensional force to the ink ribbon, and an energizing spring that energizes the ribbon guide in a direction repulsive to the pressing direction of the printing head.

Thus, the tension imparting unit is provided with the ribbon guide that imparts tensional force to the ink ribbon and the energizing spring that energizes the ribbon guide. Accordingly, the ribbon guide is pressed to the ink ribbon by energizing force of the energizing spring.

In the thermal head printer described above, it is preferable that a ribbon supply motor configured to rotate the take-up reel so as to draw out the ink ribbon from the supply reel be provided and the ribbon guide be disposed closer to the supply reel than a center between the supply reel and the take-up reel.

Thus, the ribbon supply motor that rotates the take-up reel is provided and the ribbon guide is disposed closer to the supply reel than the center between the supply reel and the take-up reel. Accordingly, the force in the direction repulsive to the pressing direction of the printing head is imparted to the ink ribbon from the tension imparting unit at a side where the ink ribbon receiving force from the printing head is easily loosened.

In the thermal head printer described above, it is preferable that the tension imparting unit be further provided with a roller guide that is supported by the ribbon tray in a rotatable manner and supports the ribbon guide, and a damper that controls rotating speed of the roller guide.

Thus, the tension imparting unit is provided with the roller guide that supports the ribbon guide and the damper that controls the rotating speed of the roller guide. Accordingly, a high-speed rotating operation of the roller guide and the ribbon guide is suppressed.

In the thermal head printer described above, it is preferable that the ribbon guide be formed in a round-shaft shape and an outer peripheral surface of the ribbon guide be pressed to the ink ribbon.

Thus, the ribbon guide is formed in the round-shaft shape and the outer peripheral surface of the ribbon guide is pressed to the ink ribbon. Accordingly, load imposed on the ink ribbon by the ribbon guide is reduced.

In the thermal head printer described above, it is preferable that the ribbon guide be supported on the roller guide in a manner to be rotatable in a shaft rotating direction.

Thus, the ribbon guide is supported on the roller guide in a manner to be rotatable in the shaft rotating direction. Accordingly, the ribbon guide is rotated in the shaft rotating direction in supply of the ink ribbon.

A thermal head printer according to an embodiment of the present invention includes a loading unit on which a printing paper that is wound in a roll shape is loaded, a conveying unit configured to send away the printing paper from the loading unit and convey the printing paper, a cutter mechanism unit configured to include a cutter that cuts the printing paper on which printing is performed, an ejecting unit to which the printing paper that is cut by the cutter is ejected, a ribbon driving unit configured to include a ribbon tray, and a supply reel and a take-up reel that are separately supported on the ribbon tray in a rotatable manner and around which an ink ribbon and the printing paper are wound, a printing head configured to be pressed to the ink ribbon and sublimate ink that is applied to the ink ribbon, so as to perform printing with respect to the printing paper, and a tension imparting unit configured to impart force in a direction repulsive to a pressing direction of the printing head to the ink ribbon when the printing head is pressed to the ink ribbon and thereby force in a direction in which the ink ribbon is drawn out from the supply reel is imparted to the ink ribbon at a part between the supply reel and the take-up reel of the ribbon driving unit.

Accordingly, looseness of the ink ribbon and printing unevenness do not occur and printing can be immediately started, enhancing printing speed.

In the embodiment of the present invention, the tension imparting unit is provided with a ribbon guide that is pressed to the ink ribbon so as to impart tensional force to the ink ribbon, and an energizing spring that energizes the ribbon guide in a direction repulsive to the pressing direction of the printing head.

Thus, the tension imparting unit has the simple configuration. The simple mechanism enables reduction in manufacturing cost and reduction in size.

In the embodiment of the present invention, a ribbon supply motor configured to rotate the take-up reel so as to draw out the ink ribbon from the supply reel is provided and the ribbon guide is disposed closer to the supply reel than a center between the supply reel and the take-up reel.

Accordingly, the occurrence of looseness of the ink ribbon can be securely prevented, effectively enabling prevention of the occurrence of printing unevenness and enhancement of the printing speed.

In the embodiment of the present invention, the tension imparting unit is further provided with a roller guide that is supported by the ribbon tray in a rotatable manner and supports the ribbon guide, and a damper that controls rotating speed of the roller guide.

Accordingly, the high-speed rotating operation of the roller guide and the ribbon guide is suppressed and thus rapid fluctuation of tensional force is suppressed, whereby the ink ribbon can be protected.

In the embodiment of the present invention, the ribbon guide is formed in a round-shaft shape and an outer peripheral surface of the ribbon guide is pressed to the ink ribbon.

Accordingly, load imposed on the ink ribbon is small, and thereby the supply operation of the ink ribbon can be smoothly performed.

In the embodiment of the present invention, the ribbon guide is supported on the roller guide in a manner to be rotatable in a shaft rotating direction.

Accordingly, the supply operation of the ink ribbon can be further smoothly performed.

### BRIEF DESCRIPTION OF THE DRAWINGS

FIG. 1 is a schematic lateral view which illustrates a thermal head printer according to an embodiment of the present invention together with FIGS. 2 to 5;

FIG. 2 is a perspective view of a ribbon driving unit;

FIG. 3 is an enlarged perspective view of a tension imparting unit;

FIG. 4 is a schematic lateral view showing a state before printing is started; and

FIG. 5 is a schematic lateral view showing a state when the printing is started.

### DESCRIPTION OF THE PREFERRED EMBODIMENTS

A thermal head printer according to an embodiment of the present invention will now be described with reference to the accompanying drawings.

### [Configuration of Thermal Head Printer]

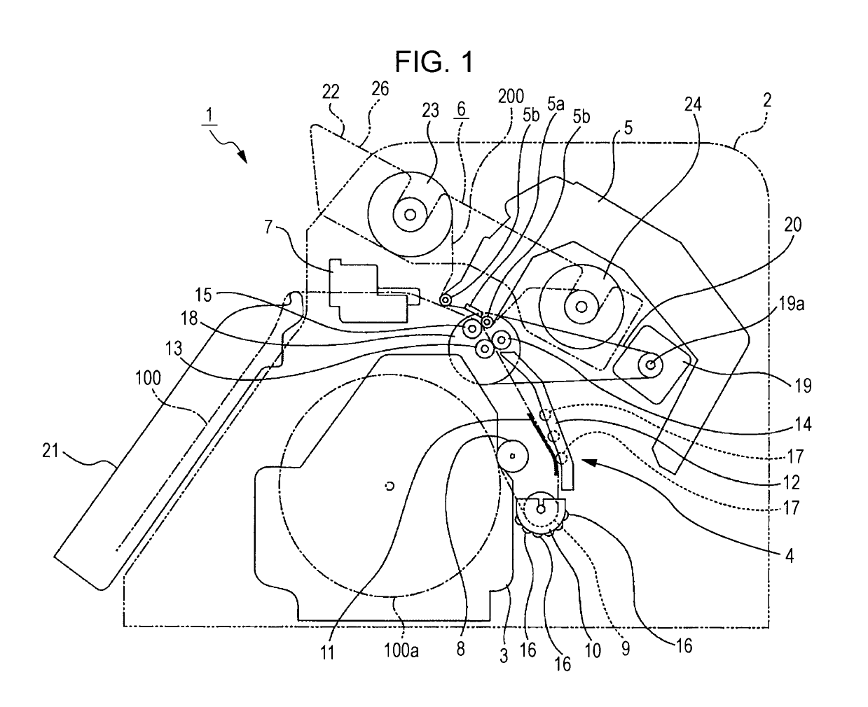

A thermal head printer 1 includes respective necessary elements which are arranged in an inside and an outside of an outer casing 2 (refer to FIG. 1).

In the inside of the outer casing 2, a loading unit 3, a conveying unit 4, a head mechanism unit 5, a ribbon driving unit 6, and cutter mechanism unit 7 are arranged.

The loading unit 3 is disposed at a lower side of the inside of the outer casing 2, and a printing paper 100 wound in a roll-shape is loaded onto the loading unit 3. A roll part 100a of the printing paper 100 which is loaded onto the loading unit 3 is set to be rotatable with respect to the loading unit 3.

The conveying unit 4 includes a paper feeding roller 8, a folding roller 9, a feeding guide 10, guides 11 and 12, a capstan 13, a pinch roller 14, and a platen roller 15.

The paper feeding roller 8 is made of a robber material, for example, and is rotated by a motor, which is not shown, at a position near a drawing-out port, from which the printing paper 100 is drawn out, of the loading unit 3. The printing paper 100 is drawn out from the loading unit 3 and conveyed by the rotation of the paper feeding roller 8.

The folding roller 9 is supported below the paper feeding roller 8 in a rotatable manner, and has a function to fold the printing paper 100, which is fed by the paper feeding roller 8, by approximately 180 degrees to make the printing paper 100 be in a U-shape state and convey the paper 100. The provision of the folding roller 9 reduces a space for forming a conveying path of the printing paper 100, realizing reduction in size. In addition, thanks to the provision of the folding roller 9, directions of the two sides of the printing paper 100 can be reversed and the loading unit 3 and an ejecting unit (ejecting tray) described later can be set in a desired direction, enhancing design flexibility and operability.

The folding roller 9 is supported by the feeding guide 10 in a rotatable manner. A plurality of feeding rollers 16, 16, . . . which are arranged along an outer peripheral surface of the folding roller 9 are supported on the feeding guide 10 in a rotatable manner.

The guides 11 and 12 are disposed above the folding roller 9. The guides 11 and 12 are arranged in an opposed manner. On the guide 12, a plurality of sending rollers 17, 17, . . . which are arranged along a conveying path of the printing paper 100 are supported in a rotatable manner.

The capstan 13 is fixed at the center of a pulley 18 which is disposed on the same axis as that of the capstan 13 and is rotated by drive force of a driving motor 19. A force transmission belt 20 is wound between a motor shaft 19a of the driving motor 19 and the pulley 18. Accordingly, the drive force of the driving motor 19 is transmitted to the capstan 13 through the force transmission belt 20 and the pulley 18 and thus the capstan 13 is rotated.

The pinch roller 14 is brought into contact with the capstan 13 with the printing paper 100 interposed therebetween and is rotated along with the rotation of the capstan 13 so as to hold the printing paper 100 together with the capstan 13 and convey the printing paper 100.

The platen roller 15 is disposed in the vicinity of the pinch roller 14. When the head mechanism unit 5 is driven in printing with respect to the printing paper 100, the printing paper 100 is pressed to the platen roller 15.

The head mechanism unit 5 includes a printing head 5a which is provided at an end part thereof and is set to be movable in a direction separating from and contacting with the printing paper 100. The head mechanism unit 5 includes ribbon rollers 5b and 5b which are disposed in the vicinity of the printing head 5a.

The ribbon driving unit 6 has a function to supply an ink ribbon 200 in printing.

The cutter mechanism unit 7 includes a cutter and has a function to cut the printing paper 100 on which printing is performed, at a predetermined position.

On the outer casing 2, an ejecting tray 21 functioning as an ejecting unit is attached. To the ejecting tray 21, the printing paper 100 on which printing is performed by the printing head 5a and which is cut by the cutter is ejected.

The ribbon driving unit 6 includes a ribbon tray 22, a supply reel 23 and a take-up reel 24 which are separately provided and rotatably supported on the ribbon tray 22, and a tension imparting unit 25 which imparts tensional force to the ink ribbon 200.

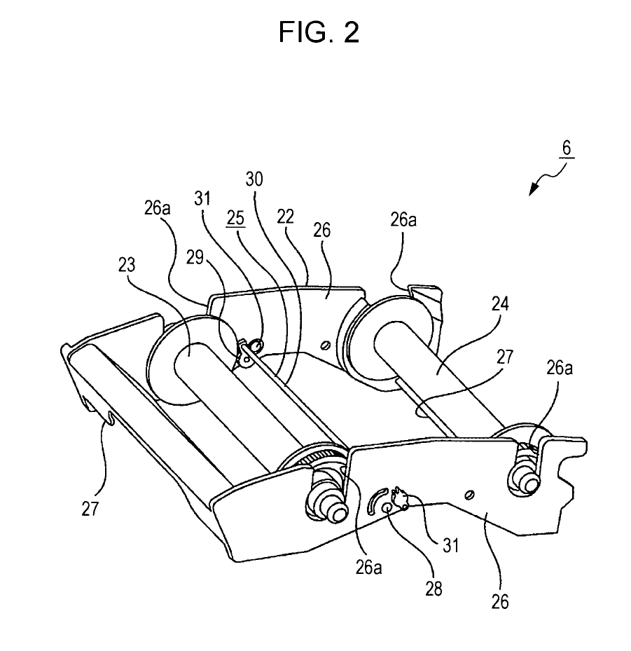

The ribbon tray 22 is formed by integrating a pair of supporting surface parts 26 and 26 which are disposed to be opposed to each other in the lateral direction and connecting parts 27 and 27 which connect the supporting surface parts 26 and 26 and are disposed in a separate fashion in the longitudinal direction (refer to FIG. 2).

On each of the supporting surface parts 26 and 26, two supporting recesses 26a and 26a which are opened upward are formed in a separate fashion in the longitudinal direction. Into the supporting recesses 26a and 26a of each of the supporting surface parts 26 and 26, end parts, in an axial direction, of the supply reel 23 and the take-up reel 24 are respectively inserted, and thus the supply reel 23 and the take-up reel 24 are separately supported by the supporting surface parts 26 and 26 in a rotatable manner.

On the supporting surface parts 26 and 26, shaft inserting holes 26b and 26b and arrangement holes 26c and 26c are formed in the vicinity of the supporting recesses 26a and 26a which are at a side in which the supply reel 23 is supported. The shaft inserting hole 26b is formed to have an arc shape.

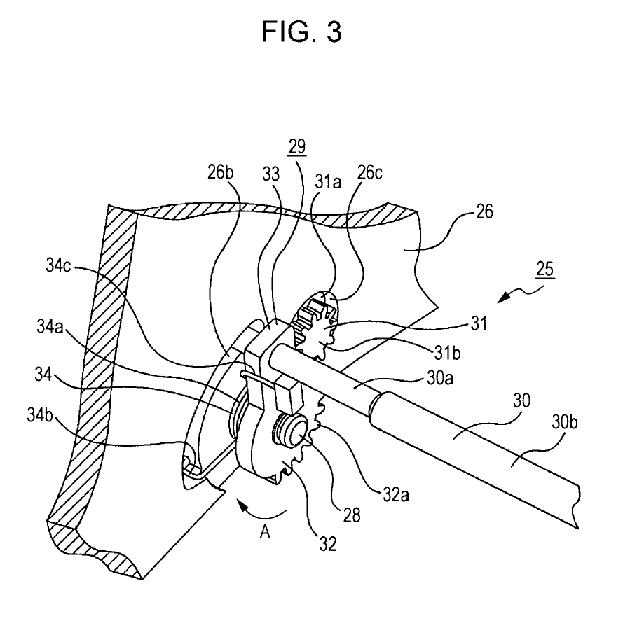

The tension imparting unit 25 is supported by the supporting surface parts 26 and 26 (refer to FIGS. 2 and 3). The tension imparting unit 25 includes supporting shafts 28 and 28, roller guides 29 and 29, a ribbon guide 30, and dampers 31 and 31.

The supporting shafts 28 and 28 are respectively attached to center parts of the arcs of shaft inserting holes 26b and 26b of the supporting surface parts 26 and 26. The supporting shafts 28 and 28 are projected to the inner surface side of the supporting surface parts 26.

The roller guides 29 and 29 are respectively supported by the supporting shafts 28 and 28. The roller guide 29 is formed by integrating a base part 32 which has an approximate circular-plate shape and has a central part which is assembled with the supporting shaft 28 and a shaft supporting projection part 33 which is projected from the base part 32. A gear part 32a is formed on a part of the outer peripheral surface of the base part 32.

The ribbon guide 30 is supported between the shaft supporting projection parts 33 and 33 of the roller guides 29 and 29 in a manner rotatable in a shaft rotating direction.

The ribbon guide 30 is rotated in a manner to be integrated with the roller guides 29 and 29 at a side closer to the supply reel 23 than the center between the supply reel 23 and the take-up reel 24. The ribbon guide 30 includes small diameter parts 30a and 30a which are both end parts thereof in the axial direction and a large diameter part 30b which has a little larger diameter than that of the small diameter parts 30a and 30a and is a part between the small diameter parts 30a and 30a.

In a state that the small diameter parts 30a and 30a of the ribbon guide 30 are respectively supported by the roller guides 29 and 29, end parts of the small diameter parts 30a and 30a are respectively inserted into the shaft inserting holes 26b and 26b.

As described above, the small diameter parts 30a and 30a are provided at both end parts of the ribbon guide 30. Accordingly, the ribbon guide 30 can be easily detached from the roller guides 29 and 29 by moving the ribbon guide 30 in the axial direction in maintenance work of the tension imparting unit 25, for example. Thus, the workability can be enhanced.

Further, a part other than the both end parts of the ribbon guide 30 is provided as the large diameter part 30b. Accordingly, the strength of the ribbon guide 30 is enhanced and therefore, the operation of supplying the ink ribbon 200 can be smoothly performed.

Energizing springs 34 and 34 are respectively supported on the supporting shafts 28 and 28. A torsion coil spring, for example, is used as the energizing springs 34.

The energizing spring 34 includes a coil part 34a, one end part 34b, and the other end part 34c. The coil part 34a is supported at a part, which is positioned between the roller guide 29 and the supporting surface part 26, of the supporting shaft 28. The one end part 34b is engaged with an edge which is at the lower side of the shaft inserting hole 26b. The other end part 34c is engaged with the shaft supporting projection part 33 of the roller guide 29. Accordingly, the roller guides 29 and 29 and the ribbon guide 30 are energized in a rotating direction A (refer to FIG. 3), in which the ribbon guide 30 moves upward, by the energizing springs 34 and 34.

The dampers 31 and 31 are respectively attached to the supporting surface parts 26 and 26. The damper 31 is composed of an oil sealing part 31a and a gear part 31b which is supported by the oil sealing part 31a in a rotatable manner. Further, in the inside of the oil sealing part 31a, an oil reception part which is laterally projected from the gear part 31b and is not shown is disposed. Oil having viscosity resistance is sealed in the inside of the oil sealing part 31a, and the oil reception part receives resistance by the oil, whereby the rotating speed of the gear part 31b is controlled.

The oil sealing part 31a of the damper 31 is attached to the outer surface side of the supporting surface part 26 and the gear part 31b of the damper 31 is projected to the inward of the supporting surface part 26 from the arrangement hole 26c. The gear parts 31b and 31b of the dampers 31 and 31 are respectively engaged with the gear parts 32a and 32a of the roller guides 29 and 29. Accordingly, the rotating speed of the roller guides 29 and 29 is controlled by the dampers 31 and 31.

The ink ribbon 200 is supplied from the supply reel 23 and taken up by the take-up reel 24. When the printing head 5a is brought closer to the printing paper 100 by an operation of the head mechanism unit 5, the ink ribbon 200 is pressed by the ribbon rollers 5b and 5b and pushed in an approaching direction to the printing paper 100, whereby a part, which is positioned between the ribbon rollers 5b and 5b, of the ink ribbon 200 is pressed to the printing paper 100 from the opposite side of the platen roller 15. In terms of the ribbon driving unit 6, the take-up reel 24 is rotated by drive force of a ribbon supply motor which is not shown and the ink ribbon 200 is supplied from the supply reel 23.

### [Printing Operation of Thermal Head Printer]

In the thermal head printer 1 configured as described above, when the printing paper 100 is taken out from the loading unit 3 to be sent away to the ejecting tray 21 by the rotation of the paper feeding roller 8, the conveyance direction of the printing paper 100 is reversed by the folding roller 9 and the printing paper 100 is guided by the feeding guide 10 and the guides 11 and 12 and conveyed toward the ejecting tray 21 by the rotation of the capstan 13. At this time, the printing paper 100 is smoothly conveyed while contacting with the feeding rollers 16, 16, . . . which are supported on the feeding guide 10 in a rotatable manner and the sending rollers 17, 17, . . . which are supported on the guide 12 in a rotatable manner.

When the printing paper 100 is conveyed on the platen roller 15, the ink ribbon 200 is supplied from the supply reel 23 and the head mechanism unit 5 is simultaneously driven so that the printing head 5a is brought close to the ink ribbon 200 and the printing paper 100. When the printing head 5a is brought close to contact with the ink ribbon 200 and the printing paper 100, a plurality of heater elements which are provided to the printing head 5a are selectively energized to be driven and ink which is applied to the ink ribbon 200 is sublimated. Thus, the printing with respect to the printing 100 is performed.

The printing paper 100 on which the printing is performed is subsequently conveyed toward the ejecting tray 21 and the printing paper 100 is cut by the cutter driven by the driving of the cutter mechanism unit 7 so as to be ejected to the ejecting tray 21.

### [Operation of Tension Imparting Unit]

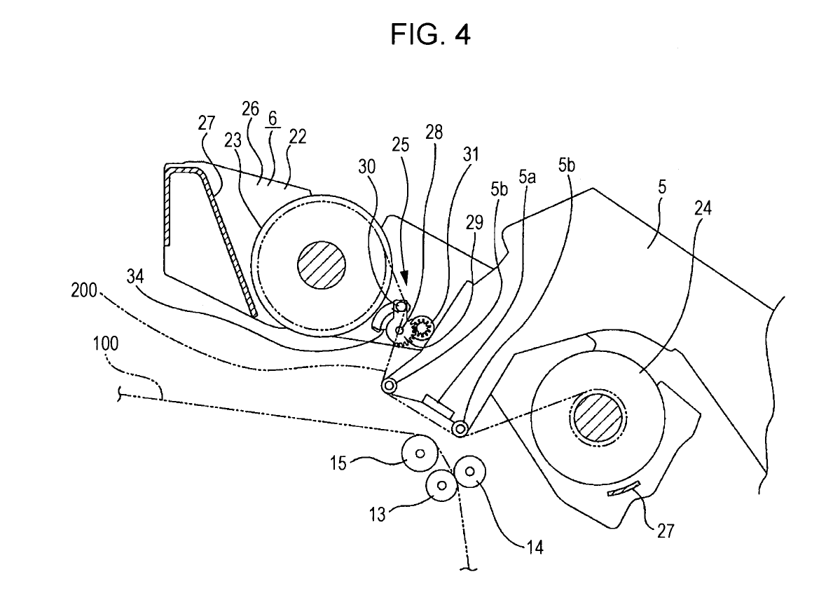

In the state before the printing operation described above is started, when the head mechanism unit 5 is on a standby position before the start of the printing, the ink ribbon 200 contacts with the ribbon rollers 5b and 5b. However, the head mechanism unit 5 is not moved in an approaching direction to the printing paper 100, so that the ink ribbon 200 and the printing paper 100 are separately positioned (refer to FIG. 4).

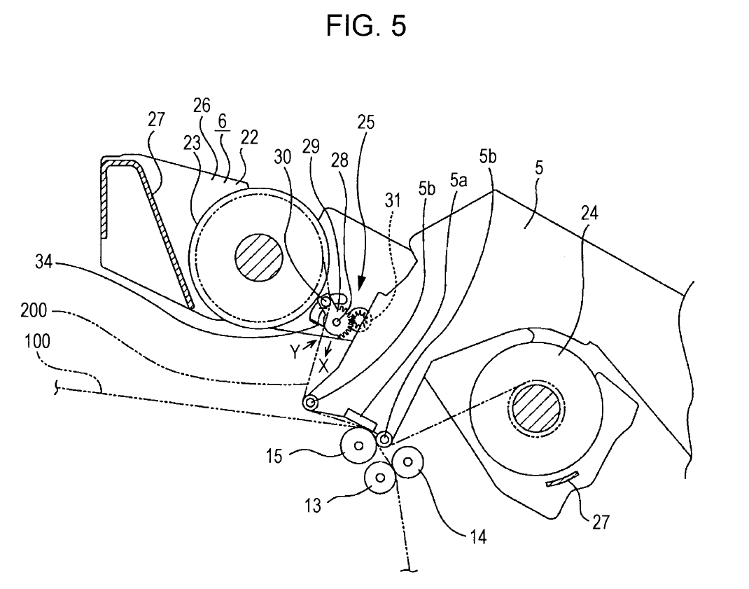

In starting of the printing operation, as described above, when the printing head 5a is brought close to the printing paper 100 by the operation of the head mechanism unit 5, the ink ribbon 200 is pressed by the ribbon rollers 5b and 5b and pushed in the approaching direction to the printing paper 100, whereby the part, which is positioned between the ribbon rollers 5b and 5b, of the ink ribbon 200 is pressed to the printing paper 100 from the opposite side of the platen roller 15 (refer to FIG. 5).

At this time, the ink ribbon 200 is pressed downward by the head mechanism unit 5 and the ink ribbon 200 receives force X in a direction in which the ink ribbon 200 is drawn out from the supply reel 23, whereby the ribbon guide 30 is rotated in an integrated manner with the roller guides 29 and 29 against the energizing force of the energizing springs 34 and 34.

The force X in the direction in which the ink ribbon 200 is drawn out from the supply reel 23 is thus imparted to the ink ribbon 200. However, the roller guides 29 and 29 and the ribbon guide 30 are energized in an upward rotating direction by the energizing force of the energizing springs 34 and 34, so that repulsive force Y repulsive to the force X is imparted from the ribbon guide 30 to the ink ribbon 200.

Thus, when the ink ribbon 200 is pressed downward by the head mechanism unit 5, tension generated by the force Y is simultaneously imparted to the ink ribbon 200 by the tension imparting unit 25, whereby the ink ribbon 200 is not loosened.

When the roller guides 29 and 29 and the ribbon guide 30 are rotated, the rotating speed of the roller guides 29 and 29 and the ribbon guide 30 is controlled by the dampers 31 and 31 and thereby the high-speed rotating operation of the roller guides 29 and 29 and the ribbon guide 30 is controlled.

### SUMMARY

As described above, the thermal head printer 1 includes the tension imparting unit 25 which imparts force in a direction repulsive to the pressing direction of the printing head 5a to the ink ribbon 200 when force in a direction in which the ink ribbon 200 is drawn out from the supply reel 23 is applied to the ink ribbon 200 by the printing head 5a.

Accordingly, when the force X in the direction in which the ink ribbon 200 is drawn out from the supply reel 23 is applied to the ink ribbon 200, tensional force is simultaneously imparted to the ink ribbon 200 by the tension imparting unit 25. Therefore, the ink ribbon 200 is not loosened and accordingly, printing unevenness does not occur and the printing can be immediately started, enhancing the printing speed.

In the thermal head printer 1, the tension imparting unit 25 is provided with the ribbon guide 30 which is pressed to the ink ribbon 200 so as to impart tensional force to the ink ribbon 200 and the energizing springs 34 and 34 which energize the ribbon guide 30. Thus, the tension imparting unit 25 has the simple configuration. The simple mechanism enables reduction in manufacturing cost and reduction in size.

Further, the ribbon guide 30 is disposed closer to the supply reel 23 than the center between the supply reel 23 and the take-up reel 24. Therefore, force in a direction repulsive to the pressing direction of the printing head 5a is imparted to the ink ribbon 200 from the tension imparting unit 25 at the side at which the ink ribbon 200 receiving force from the printing head 5a is easily loosened.

Accordingly, the occurrence of looseness of the ink ribbon 200 can be securely prevented, effectively enabling prevention of an occurrence of printing unevenness and enhancement of printing speed.

Further, the tension imparting unit 25 is provided with the dampers 31 and 31 which control the rotating speed of the roller guides 29 and 29 and the ribbon guide 30, so that high-speed rotating operation of the roller guides 29 and 29 and the ribbon guide 30 is suppressed. Accordingly, rapid fluctuation of tensional force can be suppressed and thus the ink ribbon 200 can be protected.

Furthermore, the ribbon guide 30 is formed to have a round-shaft shape and the outer peripheral surface of the ribbon guide 30 is pressed to the ink ribbon 200, so that load imposed on the ink ribbon 200 is small and a supply operation of the ink ribbon 200 can be smoothly performed.

In addition, the ribbon guide 30 is rotated in the shaft rotating direction, so that the supply operation of the ink ribbon 200 can be further smoothly performed.

The present application contains subject matter related to that disclosed in Japanese Priority Patent Application JP 2010-100046 filed in the Japan Patent Office on Apr. 23, 2010, the entire contents of which are hereby incorporated by reference.

It should be noted that the specific shapes and configurations of respective elements described in the above embodiment is merely one example of embodiments of the present invention, and therefore the technical scope of the present invention should not be limitedly interpreted.

What is claimed is:

1. A thermal head printer, comprising:
a loading unit on which a printing paper that is wound in a roll shape is loaded;
a conveying unit configured to send away the printing paper from the loading unit and convey the printing paper;
a cutter mechanism unit configured to include a cutter that cuts the printing paper on which printing is performed;
an ejecting unit to which the printing paper that is cut by the cutter is ejected;
a ribbon driving unit configured to include a ribbon tray, and a supply reel and a take-up reel that are separately supported on the ribbon tray in a rotatable manner and around which an ink ribbon and the printing paper are wound;
a printing head configured to be pressed to the ink ribbon and sublimate ink that is applied to the ink ribbon, so as to perform printing with respect to the printing paper; and
a tension imparting unit configured to impart force in a direction repulsive to a pressing direction of the printing head to the ink ribbon when the printing head is pressed to the ink ribbon and thereby force in a direction in which the ink ribbon is drawn out from the supply reel is imparted to the ink ribbon at a part between the supply reel and the take-up reel of the ribbon driving unit.

2. The thermal head printer according to claim 1, wherein the tension imparting unit is provided with a ribbon guide that is pressed to the ink ribbon so as to impart tensional force to the ink ribbon, and an energizing spring that energizes the ribbon guide in a direction repulsive to the pressing direction of the printing head.

3. The thermal head printer according to claim 2, further comprising:
a ribbon supply motor configured to rotate the take-up reel so as to draw out the ink ribbon from the supply reel; wherein
the ribbon guide is disposed closer to the supply reel than a center between the supply reel and the take-up reel.

4. The thermal head printer according to claim 2, wherein the tension imparting unit is further provided with a roller guide that is supported by the ribbon tray in a rotatable manner and supports the ribbon guide, and a damper that controls rotating speed of the roller guide.

5. The thermal head printer according to claim 2, wherein the ribbon guide is formed in a round-shaft shape and an outer peripheral surface of the ribbon guide is pressed to the ink ribbon.

6. The thermal head printer according to claim 4, wherein the ribbon guide is supported on the roller guide in a manner to be rotatable in a shaft rotating direction.
